(19) United States
(12) Patent Application Publication
(10) Pub. No.: US 2013/0048606 A1
(43) Pub. Date: Feb. 28, 2013

(54) METHODS FOR IN-SITU CHAMBER DRY CLEAN IN PHOTOMASK PLASMA ETCHING PROCESSING CHAMBER

(71) Applicants: Zhigang Mao, San Jose, CA (US); Xiaoyi Chen, Foster City, CA (US); Keven Yu, Union City, CA (US); Michael Grimbergen, Redwood City, CA (US); Madhavi Chandrahood, Sunnyvale, CA (US); Amitabh Sabharwal, San Jose, CA (US); Ajay Kumar, Cupertino, CA (US)

(72) Inventors: Zhigang Mao, San Jose, CA (US); Xiaoyi Chen, Foster City, CA (US); Keven Yu, Union City, CA (US); Michael Grimbergen, Redwood City, CA (US); Madhavi Chandrahood, Sunnyvale, CA (US); Amitabh Sabharwal, San Jose, CA (US); Ajay Kumar, Cupertino, CA (US)

(21) Appl. No.: 13/222,088

(22) Filed: Aug. 31, 2011

(51) Int. Cl. B08B 5/00; B08B 7/00; C23F 1/02

(52) U.S. Cl. 216/67

(57) ABSTRACT

Embodiments of the invention include methods for in-situ chamber dry cleaning a plasma processing chamber utilized for photomask plasma fabrication process. In one embodiment, a method for in-situ chamber dry clean after photomask plasma etching includes performing an in-situ pre-cleaning process in a plasma processing chamber, supplying a pre-cleaning gas mixture including at least an oxygen containing gas into the plasma processing chamber while performing the in-situ pre-cleaning process, providing a substrate into the plasma processing chamber, performing an etching process on the substrate, removing the substrate from the substrate, and performing an in-situ post cleaning process by flowing a post cleaning gas mixture including at least an oxygen containing gas into the plasma processing chamber.

### BACKGROUND

1. Field

Embodiments of the present invention generally relate to methods and apparatus for in-situ cleaning a plasma processing chamber utilized to etch a photomask substrate. Particularly, embodiments of the present invention relate to methods and apparatus for in-situ chamber dry cleaning a plasma processing chamber utilized to etch a photomask substrate.

2. Description of the Related Art

The fabrication of microelectronics or integrated circuit devices typically involves a complicated process sequence requiring hundreds of individual steps performed on semiconductive, dielectric and conductive substrates. Examples of these process steps include oxidation, diffusion, ion implantation, thin film deposition, cleaning, etching and lithography. Using lithography and etching (often referred to as pattern transfer steps) processes, a desired pattern is first transferred to a photosensitive material layer, e.g., a photoresist, and then to the underlying material layer during the subsequent etching process. In the lithographic step, a blanket photoresist layer is exposed to a radiation source through a reticle or photomask, which is typically formed in a metal-containing layer supported on a glass or quartz substrate, containing a pattern so that an image of the pattern is formed in the photoresist. By developing the photoresist in a suitable chemical solution, portions of the photoresist are removed, thus resulting in a patterned photoresist layer. With this photoresist pattern acting as a mask, the underlying material layer is exposed to a reactive environment, e.g., using dry etching, which results in the pattern being transferred to the underlying material layer.

An example of a commercially available photomask etch equipment suitable for use in advanced device fabrication is the TETRA® Photomask Etch System, available from Applied Materials, Inc., of Santa Clara, Calif. The metal-containing layers patterned by a plasma processing such as photomask plasma etching process offers good critical dimension control than conventional wet chemical etching in the fabrication of microelectronic devices. Plasma etching technology is widely applied in the semiconductor and thin film transistor-liquid crystal display (TFT-LCD) industry.

During dry etching photomasks in the plasma chamber, materials such as chromium (Cr), MoSi, quartz, SiON or Ta-based compounds may be deposited to form layers of film stacks. After the etching process, etching by-products may be accumulated and deposited on the inner wall of the chamber. For example, when dry etching a Cr layer disposed on the substrate, the etch by-products may predominantly be photoresist with Cr containing materials. Alternatively, when dry etching Ta, the etch by-products may predominantly be photoresist with Ta containing materials. When the deposited etch by-products reach a certain thickness, the by-products may peel off from the inner wall of the plasma chamber and contaminate the photomask by falling onto the substrate, causing irreparable defects to the photomask. Accordingly, it is important to remove and clean such deposited etching by-products periodically.

Therefore, there is a need for an improved process for cleaning plasma chamber after etching of the photomask for photomask fabrication.

### SUMMARY

Embodiments of the invention include methods for in-situ chamber dry cleaning a plasma processing chamber utilized for photomask plasma fabrication process. In one embodiment, a method for in-situ chamber dry clean after photomask plasma etching includes performing an in-situ pre-cleaning process in a plasma processing chamber, supplying a pre-cleaning gas mixture including at least an oxygen containing gas into the plasma processing chamber while performing the in-situ pre-cleaning process, providing a substrate into the plasma processing chamber, performing an etching process on the substrate, removing the substrate from the substrate, and performing an in-situ post cleaning process by flowing a post cleaning gas mixture including at least an oxygen containing gas into the plasma processing chamber.

In another embodiment, a method for cleaning a plasma processing chamber includes supplying a pre-cleaning gas mixture including an oxygen containing gas into a plasma processing chamber while maintaining a process pressure at a first range disposed in the plasma processing chamber, lowering the process pressure to a second range after supplying the pre-cleaning gas mixture for a first predetermined time period, providing a substrate to the plasma processing chamber, supplying an etching gas mixture into the plasma processing chamber to etch a metal containing layer disposed on the substrate, removing the substrate from the plasma processing chamber, supplying a post-cleaning gas mixture including an oxygen containing gas into the plasma processing chamber while maintaining the process pressure at a third range disposed in the plasma processing chamber, and lowering the process pressure to fourth second range after supplying the post cleaning gas mixture for a second predetermined time period.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 depicts a schematic diagram of a plasma processing chamber for performing photomask plasma etching processes according to one embodiment of the invention;

FIG. 2 depicts a flow chart of a method for cleaning a plasma processing chamber according to one embodiment of the invention; and

FIG. 3A-3B depicts sectional views of one embodiment of an interconnect structure disposed on a substrate at different stages of manufacture.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

Embodiments of the present invention provide methods and apparatus for in-situ chamber dry clean a plasma processing chamber utilized to perform photomask plasma etching processes.

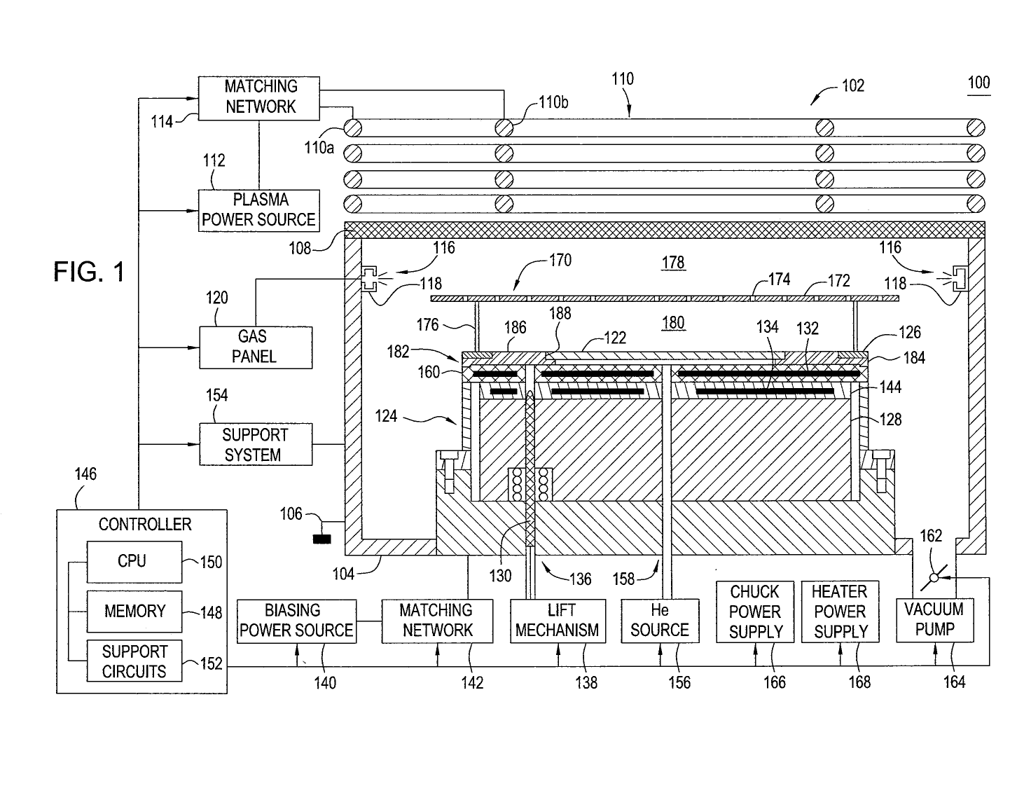

FIG. 1 depicts a schematic diagram of an etch reactor 100 in which the invention may be practiced. Suitable reactors that may be adapted for use with the teachings disclosed herein include, for example, a Decoupled Plasma Source (DPS®II) reactor, or a TETRA® Photomask etch system, all of which are available from Applied Materials, Inc. of Santa Clara, Calif. The particular embodiment of the reactor 100 shown herein is provided for illustrative purposes and should not be used to limit the scope of the invention. It is contemplated that the invention may be utilized in other plasma processing chambers, including those from other manufacturers.

The reactor 100 comprises a process chamber 102 having a substrate pedestal (e.g., cathode) 124 within a conductive body (wall) 104, and a controller 146. The process chamber 102 has a substantially flat dielectric ceiling or lid 108. The process chamber 102 may have other types of ceilings, e.g., a dome-shaped ceiling. An antenna 110 is disposed above the ceiling 108 and comprises one or more inductive coil elements (two co-axial elements 110a and 110b are shown in FIG. 1). The antenna 110 is coupled through a first matching network 114 to a plasma power source 112, which is typically capable of producing up to about 3000 W at a tunable frequency in a range from about 50 kHz to about 13.56 MHz.

The substrate support pedestal 124 is coupled through a second matching network 142 to a biasing power source 140. The biasing power source 140 provides up to about 500 W of power to the substrate support pedestal 124 at a frequency of approximately 13.56 MHz. The biasing power source 140 is capable of producing either continuous or pulsed power. Alternatively, the biasing power source 140 may be a DC or pulsed DC source.

In one embodiment, the substrate support pedestal 124 comprises an electrostatic chuck 160, which has at least one clamping electrode 132 and is controlled by a chuck power supply 166. In alternative embodiments, the substrate support pedestal 124 may comprise substrate retention mechanisms such as a susceptor cover ring, a mechanical chuck, a vacuum chuck, and the like.

A reticle adapter 182 is used to secure the substrate (e.g., mask or reticle) 122 onto the substrate support pedestal 124. The reticle adapter 182 generally includes a lower portion 184 that covers an upper surface of the substrate support pedestal 124 (for example, the electrostatic chuck 160) and a top portion 186 having an opening 188 that is sized and shaped to hold the substrate 122. The opening 188 is generally substantially centered with respect to the substrate support pedestal 124. The adapter 182 is generally formed from a single piece of etch resistant, high temperature resistant material such as polyimide ceramic or quartz. An edge ring 126 may cover and/or secure the adapter 182 to the substrate support pedestal 124.

A lift mechanism 138 is used to lower or raise the adapter 182 and the substrate 122 onto or off of the substrate support pedestal 124. Generally, the lift mechanism 138 comprises a plurality of lift pins 130 (one lift pin is shown) that travel through respective guide holes 136.

In operation, the temperature of the substrate 122 is controlled by stabilizing the temperature of the substrate support pedestal 124. In one embodiment, the substrate support pedestal 124 comprises a resistive heater 144 and a heat sink 128. The resistive heater 144 generally comprises at least one heating element 134 and is regulated by a heater power supply 168. A backside gas, e.g., helium (He), from a gas source 156 is provided via a gas conduit 158 to channels that are formed in the surface of the substrate support pedestal 124 under the substrate 122 to facilitate heat transfer between the substrate support pedestal 124 and the substrate 122. During processing, the substrate support pedestal 124 may be heated by the resistive heater 144 to a steady-state temperature, which in combination with the backside gas, facilitates uniform heating of the substrate 122. Using such thermal control, the substrate 122 may be maintained at a temperature between about 0 and 350 degrees Celsius (° C.).

An ion-radical shield 170 may be disposed in the process chamber 102 above the substrate support pedestal 124. The ion-radical shield 170 is electrically isolated from the chamber walls 104 and the substrate support pedestal 124 such that no ground path from the shield to ground is provided. One embodiment of the ion-radical shield 170 comprises a substantially flat plate 172 and a plurality of legs 176 supporting the plate 172. The plate 172, which may be made of a variety of materials compatible with process needs, comprises one or more openings (apertures) 174 that define a desired open area in the plate 172. This open area controls the amount of ions that pass from a plasma formed in an upper process volume 178 of the process chamber 102 to a lower process volume 180 located between the ion-radical shield 170 and the substrate 122. The greater the open area, the more ions can pass through the ion-radical shield 170. As such, the size of the apertures 174 controls the ion density in volume 180, and the shield 170 serves as an ion filter. The plate 172 may also comprise a screen or a mesh wherein the open area of the screen or mesh corresponds to the desired open area provided by apertures 174. Alternatively, a combination of a plate and screen or mesh may also be used.

During processing, a potential develops on the surface of the plate 172 as a result of electron bombardment from the plasma. The potential attracts ions from the plasma, effectively filtering them from the plasma, while allowing neutral species, e.g., radicals, to pass through the apertures 174 of the plate 172. Thus, by reducing the amount of ions through the ion-radical shield 170, etching of the mask by neutral species or radicals can proceed in a more controlled manner. This reduces erosion of the resist as well as sputtering of the resist onto the sidewalls of the patterned material layer, thus resulting in improved etch bias and critical dimension uniformity.

Prior to plasma etching, one or more process gases are provided to the process chamber 102 from a gas panel 120, e.g., through one or more inlets 116 (e.g., openings, injectors, nozzles, and the like) located above the substrate support pedestal 124. In the embodiment of FIG. 1, the process gases are provided to the inlets 116 using an annular gas channel 118, which may be formed in the wall 104 or in gas rings (as shown) that are coupled to the wall 104. During the etch process, a plasma formed from the process gases is maintained by applying power from the plasma power source 112 to the antenna 110.

The pressure in the process chamber 102 is controlled using a throttle valve 162 and a vacuum pump 164. The temperature of the wall 104 may be controlled using liquid-containing conduits (not shown) that run through the wall 104. Typically, the chamber wall 104 is formed from a metal (e.g., aluminum, stainless steel, among others) and is coupled to an electrical ground 106. The process chamber 102 also comprises conventional systems for process control, internal diagnostic, end point detection, and the like. Such systems are collectively shown as support systems 154. In one embodiment, Optical Emission Spectra (OES) may be used as an end point detection tool.

The controller 146 comprises a central processing unit (CPU) 150, a memory 148, and support circuits 152 for the CPU 150 and facilitates control of the components of the process chamber 102 and, as such, of the etch process, as discussed below in further detail. The controller 146 may be one of any form of general-purpose computer processor that can be used in an industrial setting for controlling various chambers and sub-processors. The memory, or computer-readable medium of the CPU 150 may be one or more of readily available memory such as random access memory (RAM), read only memory (ROM), floppy disk, hard disk, or any other form of digital storage, local or remote. The support circuits 152 are coupled to the CPU 150 for supporting the processor in a conventional manner. These circuits include cache, power supplies, clock circuits, input/output circuitry and subsystems, and the like. The inventive method discussed below is generally stored in the memory 148 as a software routine. Alternatively, such software routine may also be stored and/or executed by a second CPU (not shown) that is remotely located from the hardware being controlled by the CPU 150.

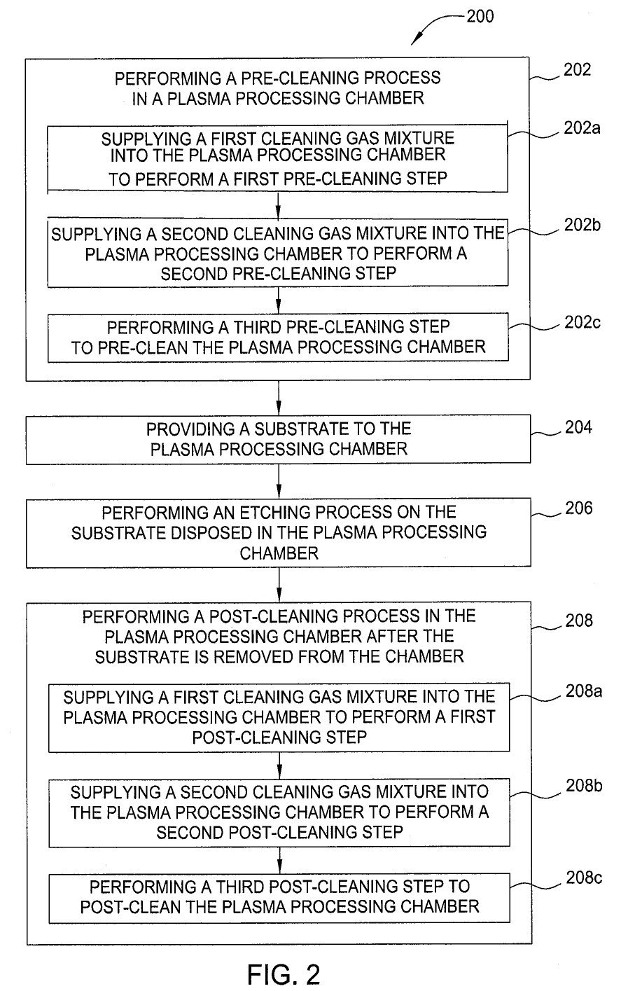

FIG. 2 illustrates a method 200 for cleaning a plasma processing chamber, such as the etch reactor 100 depicted in FIG. 1, utilized to perform photomask etching processes. The method 200 includes an in-situ chamber dry clean according to embodiments of the present invention. The method 200 begins at block 202 by performing a pre-cleaning process in the plasma processing chamber prior to a photomask etching process for a first predetermined time period. The first predetermined time period may be controlled at between about 0 seconds and about 500 seconds. When performing the pre-cleaning process, a dummy substrate, such as a clean quartz substrate without film stack disposed thereon, may be disposed in the processing chamber to protect the surface of the substrate pedestal. Alternatively, the pre-cleaning process may be performed in the processing chamber in absence of a substrate disposed therein. As the interior of the plasma processing chamber, including chamber walls, substrate pedestal, or other components disposed in the plasma processing chamber, may have film accumulation or contamination remaining thereon from the previous etching processes, a pre-cleaning process may be performed to clean the interior of the plasma processing chamber prior to providing a substrate into the plasma processing chamber for processing. The pre-cleaning process removes contaminates or film accumulation from the interior of the plasma processing chamber, thereby preventing unwanted particles from falling particular to fall on the substrate disposed on the substrate pedestal during the subsequent etching processes.

In one embodiment, the pre-cleaning process includes multiple pre-cleaning sub-blocks 202a, 202b, 202c, as shown in FIG. 2, to complete the pre-cleaning process. In a first precleaning step 202a, a first preliminarily cleaning gas mixture may be supplied into the plasma processing chamber to preliminarily clean the interior of the plasma processing chamber. The first preliminarily cleaning gas mixture includes at least a carbon-fluorine containing gas and an oxygen containing gas. It is believed that the fluorine elements contained in the carbon-fluorine assist removing the metal contaminates, such as Ta containing materials, from the interior of the plasma processing chamber. The oxygen containing gas may further assist reaction of the side products produced from the carbon-fluorine gas with the oxygen elements from the oxygen containing gas, forming volatile by products which are readily pumped out of the processing chamber. As the contaminates and/or film accumulation remaining in the interior of the processing chamber may also includes material from a photoresist layers, e.g., a carbon based material, an oxygen containing gas supplied for cleaning efficiently reacts and the removes the carbon based material from the plasma processing chamber.

In one embodiment, the carbon-fluorine containing gas as used in the first cleaning gas mixture may be selected from a group consisting of CF₄, CHF₃, CH₂F₂, C₂F₆, C₂F₈, SF₆, NF₃ and the like. The oxygen containing gas may be selected from a group consisting of O₂, N₂O, NO₂, O₃, CO, CO₂ and the like. In one example, the carbon-fluorine containing gas supplied in the first cleaning gas mixture is CF₄ and the oxygen containing gas supplied in the first cleaning gas mixture is O₂.

During first sub-block, at sub-block 202a, of the pre-cleaning process at block 202, several process parameters may be controlled. In one embodiment, the microwave power may be supplied to the plasma processing chamber between about 50 Watt and about 1500 Watt, such as about 600 Watts. The pressure of the processing chamber may be controlled at between about 0.5 milliTorr and about 500 milliTorr, such as between about 10 milliTorr and about 50 milliTorr, for example about 20 milliTorr. The carbon-fluorine containing gas supplied in the first cleaning gas mixture may be supplied into the processing chamber at a flow rate between about 1 sccm and about 1000 sccm, for example about 50 sccm. The oxygen containing gas supplied in the first cleaning gas mixture may be supplied into the processing chamber at a flow rate between about 1 sccm to about 1000 sccm, for example about 100 sccm. In one embodiment, the carbon fluorine containing gas and the oxygen containing gas supplied in the first cleaning gas mixture is supplied at a ratio between about 1:30 to about 5:1, such as between about 1:5 and about 1:1. The process may be performed between about 1 seconds and about 100 seconds.

At sub-block 202b, after supplying the first preliminarily cleaning gas mixture, a second cleaning gas mixture is supplied into the plasma processing chamber to continue cleaning the interior of the plasma processing chamber. In one embodiment, the second cleaning gas mixture includes an oxygen containing gas. As the carbon-fluorine containing gas supplied in the first cleaning gas mixture may remove metal containing materials from the interior of the plasma processing chamber, the oxygen containing gas supplied in the second cleaning gas mixture may assist removing the remaining residuals, including carbon containing residuals, from the interior of the plasma processing chamber. In one embodiment, the oxygen containing gas may be selected from a group consisting of O₂, N₂O, NO₂, O₃, CO, CO₂ and the like. In one example, the oxygen containing gas supplied in the second cleaning gas mixture is O₂.

During the second sub-block at sub-block 202b of the pre-cleaning process of block 202, several process parameters may be controlled. In one embodiment, the microwave power may be supplied to the plasma processing chamber between about 50 Watt and about 1500 Watt, such as about 600 Watts. The pressure of the processing chamber may be controlled at between about 0.5 milliTorr and about 500 milliTorr, such as between about 10 milliTorr and about 50 milliTorr, for example about 20 milliTorr. The oxygen containing gas supplied in the first cleaning gas mixture may be supplied into the processing chamber at a flow rate between about 1 sccm to about 1000 sccm, for example about 100 sccm. The process may be performed between about 1 seconds and about 300 seconds.

Subsequently, a third sub-block at sub-block 202c is performed to continuing removing contaminates and residuals from the interior of the plasma processing chamber. The second cleaning gas mixture supplied at the second sub-block at sub-block 202b is continued while the process pressure is turned down. It is believed that relatively low process pressure during the cleaning step may assist the second cleaning gas reaching to a lower portion of the plasma processing chamber, such as around or below the support pedestal. Accordingly, by lowering the process pressure from the second sub-block 202b at the third sub-block at sub-block 202c, the overall interior of the plasma processing chamber including the lower part around and below the substrate pedestal is more effectively cleaned. In one embodiment, the process pressure maintained in the third sub-block at sub-block 202c is about 20 percent and about 80 percent, such as between about 30 percent and about 50 percent, lower than the process pressure maintained during the second sub-block at sub-block 202b. In one embodiment, the process pressure may be controlled at between about 0.5 milliTorr and about 500 milliTorr, such as about 10 milliTorr and about 50 milliTorr. In one exemplary embodiment, the process pressure is lowered from 20 milliTorr at the second sub-block at sub-block 202b to 8 milliTorr at the third sub-block at sub-block 202c.

It is noted that the pre-cleaning step at block 202 is performed to clean the interior of the plasma processing chamber prior to a substrate etching process being performed. In some embodiments, since a substrate etching process is not yet performed in the plasma processing chamber and the metal containing materials, e.g., often found after an etching process, may not yet be formed or accumulated on the interior of the processing chamber, the first sub-block at 202a, may be eliminated as needed.

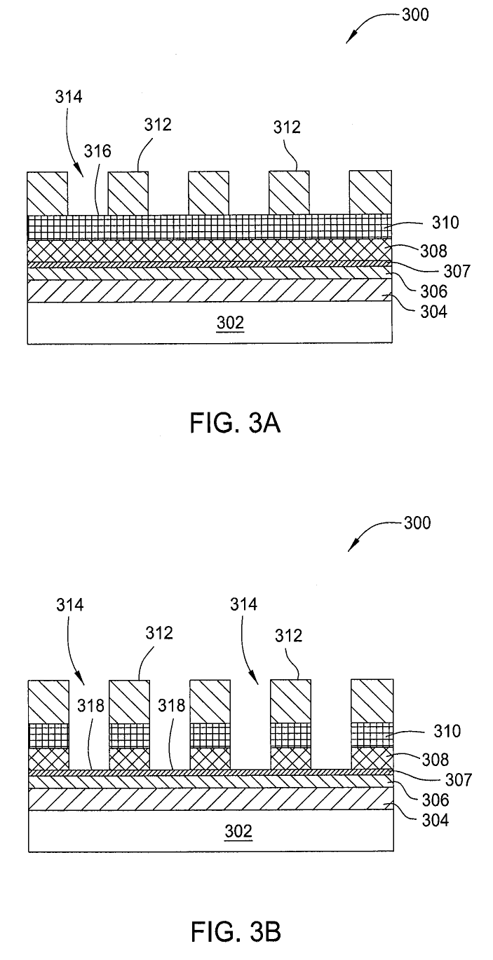

At block 204, after the pre-cleaning process is performed in the plasma processing chamber, a substrate, such as the substrate 302 depicted in FIG. 3A, may be provided into the plasma processing chamber. In one embodiment, the substrate 302 to be etched may include an optically transparent silicon based material, such as quartz (i.e., silicon dioxide, SiO₂), having a phase shift layer 304 disposed on the substrate 302. The phase shift layer 304 may be fabricated from molybdenum (Mo), molybdenum silicide, molybdenum silicon (MoSi), molybdenum silicon oxynitride (MoSiₓN_{y}O_{z}) layer or multiple layers, such as multiple pairs of molybdenum and silicon layers. A cap layer 306, fabricated from a Ruthenium (Ru) layer or a silicon layer may be disposed on the phase shift layer 304 directly. Subsequently, an optional buffer layer 307, fabricated by a chromium-containing material, such as chromium, chromium nitride, or chromium oxynitride may be disposed on the cap layer 306 as needed. Furthermore, an anti-reflective coating layer (ARC) 310 and an absorbing layer 308 may be consecutively formed on the cap layer 306 to form a film stack that facilitate light transmitting therethrough. In one embodiment, both the anti-reflective coating layer (ARC) 310 and the absorbing layer 308 may be a metal layer, such as tantalum (Ta) containing layers. In one exemplary embodiment, the anti-reflective coating layer (ARC) layer 310 is a tantalum boron oxide (TaBO) or tantalum oxide (TaO) containing layer and the absorbing layer 308 is a tantalum boron nitride (TaBN) or tantalum nitride (TaN) containing layer. After the film stack is formed on the substrate 302, a patterned photoresist layer 312 having openings 314 formed therein is disposed thereon to etch the regions 316 exposed by the patterned photoresist layer 312.

At block 206, after the substrate 302 is positioned in the plasma processing chamber, a photomask etching process is performed to etch the anti-reflective coating layer (ARC) 310 and, optionally, the absorbing layer 308, as shown in FIG. 3B, disposed on the substrate 302. Alternatively, the photomask etching process may be performed to etch the entire film stack, including the underlying optional buffer layer 307, the cap layer 306, and/or the phase shift layer/or multiple layers 304 until the substrate 302 is exposed as needed. During the etching process, one or more process gases are introduced into the plasma processing chamber to etch the Ta containing layers composed the anti-reflective coating layer (ARC) 310 and, optionally, the absorbing layer 308. Exemplary process gases used to supply to the etching gas mixture may include fluorine containing gas, such as CF₄ or CHF₃, an oxygen-containing gas, such as carbon monoxide (CO), and/or a halogen-containing gas, such as a chlorine-containing gas for etching the metal layer, such as the Ta containing materials. The processing gas may further include an inert gas. Carbon monoxide is advantageously used to form passivating polymer deposits on the surfaces, particularly the sidewalls, of openings and patterns formed in a patterned resist material and etched metal layers. Chlorine-containing gases are selected from the group of chlorine (Cl₂), silicon tetrachloride (SiCl₄), hydrochloride (HCl), and combinations thereof, and are used to supply reactive radicals to etch the metal layer.

Several process parameters may be controlled during the plasma etching substrate process. In one embodiment, the microwave power may be supplied to the plasma processing chamber between about 50 Watt and about 1500 Watt, such as about 400 Watts. The pressure of the processing chamber may be controlled at between about 0.5 milliTorr and about 500 milliTorr, such as between about milliTorr and about 0.1 milliTorr, for example about 8 milliTorr, for example about 1 milliTorr. The processing gas supplied in the etching gas mixture may be controlled at a flow rate between about 1 sccm to about 1000 sccm, for example about 80 sccm. The process may be performed between about 1 seconds and about 500 seconds.

After etching of the substrate 302 in the plasma processing chamber, the metal materials, such as the Ta containing layers, from the anti-reflective coating layer (ARC) 310 and, optionally, the absorbing layer 308 may be re-deposited, adhered, or accumulated on the interior of the plasma processing chamber. Accordingly, a post cleaning process is performed to remove contaminates, film accumulation and re-deposits from the plasma processing chamber after the substrate 302 is removed from the plasma processing chamber.

At block 208, a post cleaning process is performed for a second predetermined time period. The second predetermined time period may be controlled at between about 1 seconds and about 500 seconds. When performing the pre-cleaning process, a dummy substrate, such as a clean quartz substrate without film stack disposed thereon, may be disposed in the processing chamber to protect the surface of the substrate pedestal. Alternatively, the pre-cleaning process may be performed in the processing chamber in absence of a substrate disposed therein. The post-cleaning process includes multiple cleaning sub-blocks 208a, 208b, 208c, as shown in FIG. 2, to complete the post cleaning process. The post cleaning process is similar to the pre-cleaning step described above in block 202.

In a first post cleaning sub-block 208a, a first preliminarily cleaning gas mixture may be supplied into the plasma processing chamber to preliminarily clean the interior of the plasma processing chamber. The first preliminarily cleaning gas mixture includes at least a carbon-fluorine containing gas and an oxygen containing gas. It is believed that the fluorine elements contained in the carbon-fluorine assist removing metal contaminates, such as Ta containing materials, from the interior of the plasma processing chamber. The oxygen containing gas may further assist reaction of the by products produced from the carbon-fluorine gas with the oxygen elements from the oxygen containing gas, forming volatile by products that readily pumping out of the processing chamber. As the contaminates and/or film accumulation remaining in the interior of the processing chamber may also include sources from a photoresist layers, e.g., a carbon based material, oxygen containing gas supplied for cleaning may efficiently react and remove the carbon based material from the plasma processing chamber.

In one embodiment, the carbon-fluorine containing gas used in the first preliminarily cleaning gas mixture may be selected from a group consisting of CF₄, CHF₃, CH₂F₂, C₂F₆, C₂F₈, SF₆, NF₃ and the like. The oxygen containing gas may be selected from a group consisting of O₂, N₂O, NO₂, O₃, CO, CO₂, and the like. In one example, the carbon-fluorine containing gas supplied in the first cleaning gas mixture is CF₄ and the oxygen containing gas supplied in the first cleaning gas mixture is O₂.

During first sub-post cleaning step at sub-block 208a of the post cleaning process at block 208, several process parameters may be controlled. In one embodiment, the microwave power may be supplied to the plasma processing chamber between about 50 Watt and about 1500 Watt, such as about 600 Watts. The pressure of the processing chamber may be controlled at between about 0.5 milliTorr and about 500 milliTorr, such as between about 10 milliTorr and about 50 milliTorr, for example about 20 milliTorr. The carbon-fluorine containing gas supplied in the first cleaning gas mixture may be supplied into the processing chamber at a flow rate between about 1 sccm and about 1000 sccm, for example about 50 sccm. The oxygen containing gas supplied in the first cleaning gas mixture may be supplied into the processing chamber at a flow rate between about 1 sccm and about 1000 sccm, for example about 100 sccm. In one embodiment, the carbon fluorine containing gas and the oxygen containing gas supplied in the first cleaning gas mixture is supplied at a ratio between about 1:30 to about 5:1, such as between about 1:5 and about 1:1. The process may be performed between about 1 seconds and about 100 seconds.

At sub-block 208b, a second cleaning gas mixture is supplied into the plasma processing chamber to continue cleaning the interior of the plasma processing chamber. In one embodiment, the second cleaning gas mixture includes an oxygen containing gas. As the carbon-fluorine containing gas supplied in the first cleaning gas mixture may remove metal containing materials from the interior of the plasma processing chamber, the oxygen containing gas supplied in the second cleaning gas mixture may assist removing the remaining residuals, including carbon containing residuals, from the interior of the plasma processing chamber. In one embodiment, the oxygen containing gas may be selected from a group consisting of O₂, N₂O, NO₂, O₃, CO, CO₂ and the like. In one example, the oxygen containing gas supplied in the second cleaning gas mixture is 0₂.

During the second sub-post cleaning step at sub-block 208b of the post cleaning process at block 208, several process parameters may be controlled. In one embodiment, the microwave power may be supplied to the plasma processing chamber between about 50 Watt and about 1500 Watt, such as about 600 Watts. The pressure of the processing chamber may be controlled at between about 0.5 milliTorr and about 500 milliTorr, such as between about 10 milliTorr and about 50 milliTorr, for example about 20 milliTorr. The oxygen containing gas supplied in the first cleaning gas mixture may be supplied into the processing chamber at a flow rate between about 1 sccm to about 1000 sccm, for example about 100 sccm. The process may be performed between about 1 seconds and about 300 seconds.

Subsequently, a third sub-post cleaning step at sub-block 208c is performed to continuing removing contaminates and residuals from the interior of the plasma processing chamber. The pressure of the second cleaning gas mixture supplied at the second sub-block at sub-block 208b is reduced. It is believed that relatively low process pressure during the cleaning step may assist the second cleaning gas reach to a lower portion of the plasma processing chamber, such as around or below the support pedestal. Accordingly, by lowering the process pressure from the second post cleaning sub-block 208b at the third sub-post cleaning step at sub-block 208c, the overall interior of the plasma processing chamber including the lower part around and below the substrate pedestal, may be more effectively cleaned. In one embodiment, the process pressure maintained in the third sub-post cleaning step at sub-block 208c is about 20 percent and about 80 percent, such as between about 30 percent and about 50 percent, lower than the process pressure maintained in the second sub-post cleaning step at sub-block 208b. In one embodiment, the process pressure may be controlled at between about 0.5 milliTorr and about 500 milliTorr, such as about 10 milliTorr and about 50 milliTorr. In one exemplary embodiment, the process pressure is lowered from 20 milliTorr at the second sub-block at sub-block 202b to 8 milliTorr at the third sub-post cleaning step at sub-block 208c.

Accordingly, methods and apparatus for performing an in-situ cleaning process are provided to clean a plasma processing chamber without breaking vacuum. The methods includes a multiple cleaning steps of a pre-cleaning process and a post cleaning process to clean a plasma processing chamber prior to and after a plasma photomask etching process. The multiple cleaning steps of the pre-cleaning process and the post cleaning process may efficiently remove the residuals, re-deposits and film layer with different types of materials, including material contaminates and carbon containing contaminates, from the interior of the plasma processing chamber, thereby maintaining the plasma processing chamber in a desired clean condition and producing high quality photomask without particular pollution.

While the foregoing is directed to embodiments of the present invention, other and further embodiments of the invention may be devised without departing from the basic scope thereof, and the scope thereof is determined by the claims that follow.

1. A method for in-situ chamber dry clean after photomask plasma etching, comprising:
performing an in-situ pre-cleaning process in a plasma processing chamber;
supplying a pre-cleaning gas mixture including at least an oxygen containing gas into the plasma processing chamber while performing the in-situ pre-cleaning process;
providing a substrate into the plasma processing chamber;
performing an etching process on the substrate;
removing the substrate from the substrate; and
performing an in-situ post cleaning process by flowing a post cleaning gas mixture including at least an oxygen containing gas into the plasma processing chamber.

2. The method of claim 1, wherein supplying the pre-cleaning gas mixture further comprises:
supplying a preliminary cleaning gas mixture into the plasma processing chamber prior to supplying the pre-cleaning gas mixture.

3. The method of claim 2, wherein the preliminary cleaning gas mixture includes at least a carbon fluorine containing gas and an oxygen containing gas.

4. The method of claim 3, wherein the carbon fluorine containing gas is selected from a group consisting of CF₄, CHF₃, CH₂F₂, C₂F₆, C₂F₈, SF₆ and NF₃.

5. The method of claim 3, wherein the oxygen containing gas is selected from a group consisting of O₂, N₂O, NO₂, O₃, CO and CO₂.

6. The method of claim 3, wherein the carbon fluorine containing gas and the oxygen containing gas is supplied at a ratio between about 1:20 to about 1:1.

7. The method of claim 1, wherein flowing a post cleaning gas mixture further comprises:
supplying a preliminary cleaning gas mixture into the plasma processing chamber prior to supplying the post cleaning gas mixture.

8. The method of claim 7, wherein the preliminary cleaning gas mixture includes at least a carbon fluorine containing gas and an oxygen containing gas.

9. The method of claim 8, wherein the carbon fluorine containing gas is selected from a group consisting of CF₄, CHF₃, CH₂F₂, C₂F₆, C₂F₈, SF₆ and NF₃.

10. The method of claim 8, wherein the oxygen containing gas is selected from a group consisting of O₂, N₂O, NO₂, O₃, CO, and CO₂.

11. The method of claim 8, wherein the carbon fluorine containing gas and the oxygen containing gas is supplied at a ratio between about 1:30 to about 5:1.

12. The method of claim 1, wherein performing the etching process on the substrate further comprises:
etching a metal material disposed on the substrate.

13. The method of claim 12, wherein the metal material is a Ta containing material.

14. The method of claim 1, wherein supplying the pre-cleaning gas mixture further comprises:
adjusting a process pressure maintained while supplying the pre-cleaning gas mixture after a predetermined time period.

15. The method of claim 14, wherein adjusting the process pressure further comprising:
adjusting a process pressure to a low pressure to about 1 milliTorr and about 50 milliTorr after supplying the pre-cleaning gas mixture for the predetermined time period

16. A method for cleaning a plasma processing chamber comprising:
supplying a pre-cleaning gas mixture including an oxygen containing gas into a plasma processing chamber while maintaining a process pressure at a first range;
lowering the process pressure to a second range after supplying the pre-cleaning gas mixture for a first predetermined time period;
providing a substrate to the plasma processing chamber;
supplying an etching gas mixture into the plasma processing chamber to etch a metal containing layer disposed on the substrate;
removing the substrate from the plasma processing chamber;
supplying a post-cleaning gas mixture including an oxygen containing gas into the plasma processing chamber while maintaining the process pressure at a third range disposed in the plasma processing chamber; and
lowering the process pressure to fourth second range after supplying the post cleaning gas mixture for a second predetermined time period.

17. The method of claim 16, wherein supplying the post-cleaning gas mixture further comprises:
supplying a preliminary gas mixture including a carbon-fluorine containing gas and an oxygen containing gas into the plasma processing chamber prior to supplying the post-cleaning gas mixture.

18. The method of claim 17, wherein the carbon fluorine containing gas and the oxygen containing gas is supplied at a ratio between about 1:20 to about 1:1.

19. The method of claim 16, wherein the metal containing layer disposed on the substrate is a Ta containing material.

20. The method of claim 16, wherein the second range of the process pressure is lower than the first range of the process pressure.
